(19) United States
(12) Patent Application Publication
(10) Pub. No.: US 2019/0056146 A1
(43) Pub. Date: Feb. 21, 2019

(54) VOLTAGE CONVERTER, ACTUATOR AND GAS BURNER

(71) Applicant: BOSCH TERMOTECNOLOGIA S.A., Cacia Aveiro (PT)

(72) Inventors: Jose Oliveira, Branca (PT); Luis Terra Ferreira, Avanca (PT)

(21) Appl. No.: 16/072,112

(22) PCT Filed: Jan. 25, 2017
(86) PCT No.: PCT/EP2017/051455

§ 371 Date: Jul. 23, 2018

(30) Foreign Application Priority Data
Jan. 25, 2016 (PT) 109102

(51) Int. Cl. F24H 9/20; H02M 3/156; F23N 1/00

(52) U.S. Cl. CPC F24H 9/2035; F23N 2035/14; F23N 1/005; H02M 3/156

(57) ABSTRACT

An electrical step-down converter comprises a circuit input and a circuit output, which have a common reference potential, furthermore a flow-control valve having an inlet and an outlet, the inlet being connected to the circuit input; a coil, which is connected between the outlet of the flow-control valve and the circuit output; a diode, which is inserted in the forward direction from the reference potential to the outlet of the flow-control valve; an output capacitor between the circuit output and the reference potential; and a control device for periodically opening and closing the flow-control valve. A Zener diode is inserted between the anode of the diode and the reference potential with a forward direction to the reference potential and a resistor is provided in parallel to the diode.

### FIELD

The present invention relates to a technology for providing a current for controlling an actuator. The present invention relates in particular to controlling an actuator that is designed to operate a gas valve.

### BACKGROUND INFORMATION

A gas burner for heating water comprises a ventilator for generating a volume flow of air and a gas valve. The gas valve comprises a moving coil and is proportionally controllable between a closed and an open state in order to control a flow of combustible gas through the valve. The flow of gas through the gas valve is normally a function of a current flowing through the moving coil.

A current control for the moving coil may comprise a linear regulator, which is able to adjust the gas valve in a great range, but which has a relatively low efficiency factor and normally produces so much electrical waste heat that a cooling body is required to dissipate it. In a second specific embodiment, a clocked current controller, in particular a clocked step-down converter or buck converter is used to control the current through the moving coil. The step-down converter comprises a flow-control valve, which may be opened and closed periodically using a control device, a pulse-duty factor of a control signal controlling the voltage applied on a circuit output of the step-down converter and thus indirectly also controlling the current flowing through the moving coil. Since the flow-control valve is not able to open and close with infinite speed, at very small pulse-duty factors near 0% it is no longer possible to use the step-down converter. It is thus not possible to control a very slight flow of gas with precision.

It is an object of the present invention to provide an improved technology for an electrical step-down converter that remedies at least one of the mentioned problems. Example embodiment of the present invention are described herein.

### SUMMARY

In accordance with an example embodiment of the present invention, an electrical step-down converter comprises a circuit input and a circuit output, which have a common reference potential, furthermore a flow-control valve having an inlet and an outlet, the inlet being connected to the circuit input; a coil, which is connected between the outlet of the flow-control valve and the circuit output; a diode, which is inserted in the forward direction from the reference potential to the outlet of the flow-control valve; an output capacitor between the circuit output and the reference potential; and a control device for periodically opening and closing the flow-control valve. A Zener diode is inserted between the anode of the diode and the reference potential with a forward direction to the reference potential, and a resistor is provided in parallel to the diode.

The step-down converter is able to combine advantages of a linear converter and of a conventional step-down converter. In particular, the described step-down converter is able to cover a great dynamic range in that on an Ohmic resistor on its output it is able to set very precise currents between a few milliamperes and several hundred milliamperes. At the same time, the step-down converter may be highly efficient. In practice, it is possible to achieve an efficiency factor clearly above 50%, at times up to approx. 95%.

In a particularly preferred specific embodiment, an input capacitor is provided between the circuit input and the reference potential. It is thereby possible to provide an improved stabilization of the input voltage on the circuit input such that the input voltage may remain essentially stable both when opening as well as when closing the flow-control valve. The step-down converter is able to operate more precisely as a result. Moreover, this makes it possible to reduce the load on a voltage source for supplying the circuit input. There may be a reduction of interference in other consumers that are likewise connected to the circuit input.

A current-controlled actuator comprises a moving coil and the above-described step-down converter, the moving coil being electrically connected to the circuit output such that an actuating position controlled by the actuator depends on a flow of current through the moving coil effected by the step-down converter. This makes it possible to control the actuator precisely and in a low-loss manner.

A control device of the step-down converter is able to control the flow-control valve by a pulse-modulated signal (pulse width modulation: PWM) with a pulse-duty factor D such that the actuating position of the moving coil is controllable via the pulse-duty factor D. The PWM signal may be generated by a PWM generator such that the control device only needs to specify the pulse-duty factor D and thus only a slight load is placed on it for generating the control signal.

The current-controlled actuator may be used in particular for controlling a valve, for example a gas valve. For this purpose, the actuator preferably acts on the gas valve in such a way that a degree of opening of the gas valve is a function of the flow of current effected by the step-down converter. The actuator is able to control the gas valve precisely from a minimally open position to a maximally open position.

Preferably, the control device of the step-down converter controls the flow-control valve using a pulse-modulated signal with a pulse-duty factor in such a way that an actuating position of the moving coil may be controlled via the pulse-duty factor.

It is possible to generate the pulse-duty factor particularly easily using an integrated microcomputer or another integrated control device. This makes it possible to integrate the control of the actuator better even in a more complex device, in which other processes are already controlled by the control device.

A gas burner comprises a controllable gas valve having a moving coil and the above-described actuator for controlling the gas valve. By improving the control of a flow of gas through the gas valve it is possible to control an improved combustion so as to increase an efficiency of the gas burner. At the same time it is possible to reduce an environmental impact by pollutants.

The gas burner preferably comprises also a ventilator for generating a volume flow of air in the area of a gas outlet of the gas valve, the ventilator being controllable by the same control device. Using the control device, it is possible in particular to improve the adaptation of a rotational speed of the ventilator and a flow of gas through the gas valve with respect to each other. The adaptation may occur as a function of a parameter that is influenced by the combustion of gas with oxygen from the air, for example a flame temperature.

### BRIEF DESCRIPTION OF THE DRAWINGS

The present invention is described in greater detail with reference to the figures.

FIG. 1 shows a schematic representation of a ventilated gas burner.

FIG. 2 shows a circuit diagram of an electrical step-down converter.

### DETAILED DESCRIPTION OF EXAMPLE EMBODIMENTS

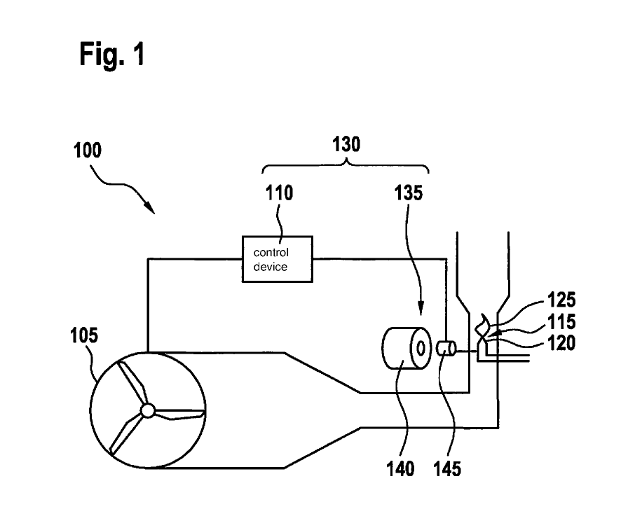

FIG. 1 shows a schematic representation of a gas burner 100. Gas burner 100 preferably comprises a ventilator 105 for providing a volume flow of air and a control device 110 for controlling ventilator 105. Control device 110 is designed in particular to control a rotational speed of ventilator 105. The volume flow provided by ventilator 105 passes a gas outlet 115 of a gas valve 120 so that gas leaving gas outlet 115 is able to be mixed with the volume flow of air and be ignited to form a flame 125. Flame 125 may be used in particular to heat a liquid, in particular water, for example by way of a heat exchanger. Gas burner 100 may be used in particular in a hot water system, for example in a heater. The heater may be designed to provide hot water in an apartment or a house.

Gas valve 120 is connected to an actuator 130 in order to open or close gas valve 120. Actuator 130 comprises a moving coil 135, also called a plunger coil, and a control device that is integrated into control device 110 in the specific embodiment shown. Moving coil 135 comprises a permanent magnet 140 having a recess and a moving coil carrier 145, which is designed to plunge into the recess. An electrical coil is attached on moving coil carrier 145, which generates a magnetic field when current is running through it, which magnetic field pulls the moving coil carrier 145 in the magnetic field of permanent magnet 140 into the recess or pulls it out of the recess. This principle is conventional in the technical field of loudspeakers. An elastic element, for example a diaphragm, provides a suitable return force onto moving coil carrier 145 so that moving coil carrier 145 is returned into a normal position when current no longer flows through the coil. Moving coil carrier 145 is preferably connected in such a way to gas valve 120 that the position of moving coil carrier 145 in the recess is proportional to a degree of opening of gas valve 120.

In order to control the combustion of flame 125, control device 110 must usually be designed to control both ventilator 105 as well as actuator 130 using moving coil 135. A change of the position of actuator 130 usually occurs relatively slowly.

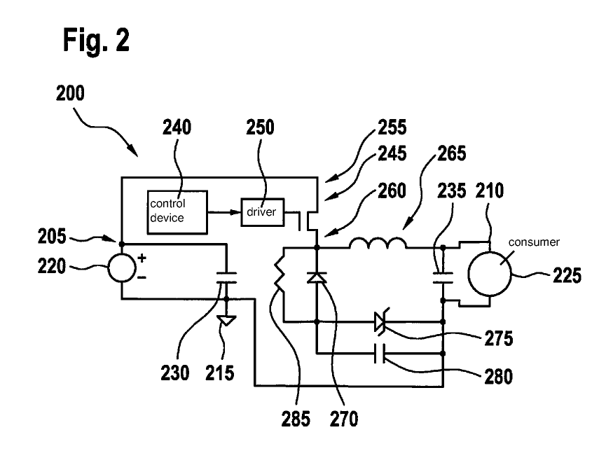

FIG. 2 shows a circuit diagram of an electrical step-down converter 200. Step-down converter 200 comprises a circuit input 205 and a circuit output 210, which refer to a common reference potential 215. A voltage source 220 is provided between circuit input 205 and reference potential 215. A consumer 225 is provided between circuit output 210 and reference potential 215, which may comprise in particular actuator 130 and further preferably moving coil 135. An input capacitor 230 is preferably connected in parallel to voltage source 220. Preferably, an output capacitor 235 is likewise connected in parallel to consumer 225.

A control device 240, which may be integrated with control device 110 from FIG. 1, controls a flow-control valve 245, for the purpose of which an interposed driver 250 may be provided. Flow-control valve 245 normally comprises a semiconductor, in particular a transistor, for example of the FET or IGBT type. An input 255 of flow-control valve 245 is connected to circuit input 205. An output 260 of flow-control valve 245 is connected to a coil 265, the second end of which is connected to circuit output 210. The output 260 of flow-control valve 245 is also connected to a diode 270, whose anode in a known circuit is directly connected to reference potential 215.

In the specific embodiment shown here, the anode of diode 270 is connected via a Zener diode 275 to reference potential 215, the cathode of Zener diode 275 pointing toward reference potential 215. A capacitor 280 is preferably connected in parallel to Zener diode 275. A resistor 285 is also preferably provided in parallel to diode 270.

Control device 240 is designed to open and close flow-control valve 245 periodically, for the purpose of which a pulse-width modulated (PWM) signal having a predetermined pulse-duty factor may be used. The pulse-duty factor may usually be changed in a range between 0% and 100%. A period duration of the PWM signal is markedly shorter than the period of an adjustment of the pulse-duty factor.

The voltage on consumer 225 is determined in a usual step-down converter 200 as the product of an efficiency factor, a voltage of voltage source 220 and the pulse-duty factor D. Consumer 225 has a predetermined resistive (Ohmic) resistance so that a current flows through consumer 225 that is determined as the quotient of the voltage on circuit output 210 of step-down converter 200 and resistor 285. Here it must be taken into consideration that the efficiency factor at a constant resistance of consumer 225 is a function of the voltage on circuit input 205 and pulse-duty factor D.

In the circuit shown above, the output voltage is reduced by an absolute value K, which is determined by the Zener voltage of Zener diode 275.

Capacitor 280 above Zener diode 275 is used for damping in order to improve a stable behavior of the regulation and thus of the voltage on consumer 225. Resistor 285 polarizes diode 270.

The step-down converter 200 shown is able to ensure a precise and repeatable control of the voltage on consumer 225 or of the current flowing through it by a suitable choice of a pulse-duty factor D of the PWM signal of control device 240. Control device 240 may advantageously also be used to control another parameter such as in the example from FIG. 1 of ventilator 105.

1-6. (canceled)

7. An electrical step-down converter having a circuit input and a circuit output, which have a common reference potential, the step-down converter comprising:
a flow-control valve having an inlet and an outlet, the inlet being connected to the circuit input;
a coil which is connected between the outlet of the flow-control valve and the circuit output;
a diode which is inserted in a forward direction from the reference potential to the outlet of the flow-control valve;
an output capacitor between the circuit output and the reference potential;
a control device for opening and closing the flow-control valve periodically;
a Zener diode with a forward direction to the reference potential inserted between an anode of the diode and the reference potential); and
a resistor in parallel to the diode.

8. The step-down converter as recited in claim 7, further comprising:
an input capacitor provided between the circuit input and the reference potential.

9. A current-controlled actuator, comprising:
a moving coil; and
a step-down converter having a circuit input and a circuit output, which have a common reference potential, the step-down converter including:
a flow-control valve having an inlet and an outlet, the inlet being connected to the circuit input,
a coil which is connected between the outlet of the flow-control valve and the circuit output,
a diode which is inserted in a forward direction from the reference potential to the outlet of the flow-control valve,
an output capacitor between the circuit output and the reference potential,
a control device for opening and closing the flow-control valve periodically,
a Zener diode with a forward direction to the reference potential inserted between an anode of the diode and the reference potential, and
a resistor in parallel to the diode;
wherein the moving coil is electrically connected to the circuit output such that an actuating position controlled by the actuator depends on a flow of current through the moving coil effected by the step-down converter.

10. The actuator s recited in claim 9, wherein the control device of the step-down converter controls the flow-control valve using a pulse-modulated signal with a pulse-duty factor in such a way that an actuating position of the moving coil is controlled via the pulse-duty factor.

11. A gas burner, comprising:
a controllable gas valve; and
as a current-controlled actuator for controlling the gas valve, the actuator including:
a moving coil, and
a step-down converter having a circuit input and a circuit output, which have a common reference potential, the step-down converter including:
a flow-control valve having an inlet and an outlet, the inlet being connected to the circuit input,
a coil which is connected between the outlet of the flow-control valve and the circuit output,
a diode which is inserted in a forward direction from the reference potential to the outlet of the flow-control valve,
an output capacitor between the circuit output and the reference potential,
a control device for opening and closing the flow-control valve periodically,
a Zener diode with a forward direction to the reference potential inserted between an anode of the diode and the reference potential, and
a resistor in parallel to the diode;
wherein the moving coil is electrically connected to the circuit output such that an actuating position controlled by the actuator depends on a flow of current through the moving coil effected by the step-down converter
wherein the actuator acting on the gas valve in such a way that a degree of opening of the gas valve depends on the flow of current effected by the step-down converter.

12. The gas burner as recited in claim 11, further comprising:
a ventilator for generating a volume flow of air in the area of a gas outlet of the gas valve, the ventilator being controllable by the same control device.
